(19) United States
(12) Patent Application Publication
(10) Pub. No.: US 2025/0362543 A1
(43) Pub. Date: Nov. 27, 2025

(54) DISPLAY DEVICE AND HEAD-UP DISPLAY DEVICE

(71) Applicant: Nippon Seiki Co., Ltd., Niigata (JP)

(72) Inventors: Yohei Fukino, Niigata (JP); Yujiro Inoue, Niigata (JP)

(21) Appl. No.: 19/188,172

(22) Filed: Apr. 24, 2025

(30) Foreign Application Priority Data
May 27, 2024 (JP) 2024-085304
Feb. 27, 2025 (JP) 2025-029751

(51) Int. Cl. G02F 1/1335; G02B 27/01

(52) U.S. Cl. CPC G02F 1/133607; G02B 27/0101

(57) ABSTRACT

A display device that emits display light representing an image, includes: a light source that emits illumination light; a third lens that collimates the illumination light from the light source; surfaces and that distribute the illumination light collimated by the third lens and are arranged on an optical axis of the collimated illumination light; and a display surface that receives the illumination light distributed by the surfaces and to emit the display light and is provided in a direction inclined with respect to an optical axis of the emitted display light. Any of the surfaces and is a Fresnel lens surface provided in a direction along the display surface. Any of the surfaces and other than the Fresnel lens surface is a cylindrical lens surface or a biconic lens array surface.

### TECHNICAL FIELD

The present disclosure relates to a display device and a head-up display device.

### BACKGROUND ART

For example, a head-up display device described in Patent Document 1 includes a light source, first to third lenses through which light from the light source passes, a liquid crystal display panel that receives the light that has passed through the first to third lenses and emits display light, and a concave mirror that displays a virtual image by reflecting the display light from the liquid crystal display panel toward a projection target member such as a front windshield. The first lens substantially collimates the light from the light source. The second lens and the third lens diffuse and distribute light in accordance with the liquid crystal display panel and the virtual image visible range.

### PRIOR ART DOCUMENT

### Patent Document

Patent Document 1: Japanese Unexamined Patent Publication No. 2020-160293

### SUMMARY OF INVENTION

### Technical Problem

In the configuration described in Patent Document 1, αthere is room for improvement in the arrangement and type of each lens from the viewpoint of the uniformity of illumination with respect to the liquid crystal display panel.

The present disclosure has been made in view of the above-described circumstances, and an object of the present disclosure is to provide a display device and a head-up display device capable of further increasing the uniformity.

### Solution to Problem

In order to achieve the above-described object, a display device according to a first aspect of the present disclosure is a display device that emits display light representing an image, including: a light source that emits light; a collimating means for collimating the light from the light source; a plurality of light distribution optical surfaces that distribute the light collimated by the collimating means and are arranged on an optical axis of the collimated light; and a display surface that receives the light distributed by the plurality of light distribution optical surfaces to emit the display light and is provided in a direction inclined with respect to an optical axis of the emitted display light, in which a first light distribution optical surface of any of the plurality of light distribution optical surfaces is a Fresnel lens surface provided in a direction along the display surface, and a second light distribution optical surface of any of the plurality of light distribution optical surfaces is a lenticular lens surface or a biconic lens array surface.

In order to achieve the above-described object, a head-up display device according to a second aspect of the present disclosure includes: the display device; and a mirror that reflects the display light from the display device, in which the mirror reflects the display light so as to cross an upper end and a lower end of the display light, which are both ends in the vertical direction, the Fresnel lens surface as the first light distribution optical surface is a linear Fresnel lens surface obtained by forming a Fresnel lens from a convex lens that extends linearly with a curvature of zero in the horizontal direction and has a convex shape in the vertical direction, and the vertical direction and the horizontal direction are set to be orthogonal to the optical axis of the collimated light and in directions orthogonal to each other.

### ADVANTAGEOUS EFFECTS OF INVENTION

According to the present disclosure, the uniformity can be further increased.

### BRIEF DESCRIPTION OF DRAWINGS

FIG. 1 is a schematic cross-sectional view of a head-up display device in a cross optical system according to an embodiment of the present disclosure.

FIG. 2 is a schematic cross-sectional view of a display device when viewed from a horizontal direction according to the embodiment of the present disclosure.

FIG. 3 is a perspective view of a cylindrical lens surface according to the embodiment of the present disclosure.

FIG. 4 is a perspective view of a concentric Fresnel lens surface according to the embodiment of the present disclosure.

FIG. 5 is a cross-sectional view of the concentric Fresnel lens surface according to the embodiment of the present disclosure.

FIG. 6 is a schematic cross-sectional view of the display device when viewed from the horizontal direction according to a modification of the embodiment of the present disclosure.

FIG. 7 is a perspective view of a horizontal light distribution linear Fresnel lens surface according to the embodiment of the present disclosure.

FIG. 8 is a front view of the horizontal light distribution linear Fresnel lens surface according to the embodiment of the present disclosure.

FIG. 9 is a perspective view of a vertical light distribution linear Fresnel lens surface according to the embodiment of the present disclosure.

FIG. 10 is a front view of the vertical light distribution linear Fresnel lens surface according to the embodiment of the present disclosure.

FIG. 11 is a perspective view of a biconic lens array surface according to the embodiment of the present disclosure.

FIG. 12 illustrates, in the upper part, a light intensity distribution in a vertical direction in a configuration in which the cylindrical lens surface is parallel to a display surface and, in the lower part, the light intensity distribution in the vertical direction in a configuration in which the cylindrical lens surface is orthogonal to a parallel light traveling direction according to the embodiment of the present disclosure.

FIG. 13 is a table showing a configuration of each lens surface in each lens pattern under a condition B1 according to the embodiment of the present disclosure.

FIG. 14 is a table showing a configuration of each lens surface in each lens pattern under a condition B2 according to the embodiment of the present disclosure.

FIG. 15 is a table showing a configuration of each lens surface in each lens pattern under a condition B3 according to the embodiment of the present disclosure.

FIG. 16 is a table showing a configuration of each lens surface in each lens pattern under a condition B4 according to the embodiment of the present disclosure.

FIG. 17 illustrates, in the upper part, a schematic view illustrating an image display region on the display surface and, in the lower part, a schematic view illustrating light sources and dimming zones according to the embodiment of the present disclosure.

FIG. 18 is a schematic cross-sectional view illustrating a part of a Fresnel lens surface according to the embodiment of the present disclosure.

FIG. 19 is a schematic cross-sectional view of a head-up display device in a non-cross optical system according to a modification of the present disclosure.

FIG. 20 is a schematic cross-sectional view of a display device when viewed from the horizontal direction according to a modification of the present disclosure.

FIG. 21 is a perspective view of a lens having the concentric Fresnel lens surface according to the embodiment of the present disclosure.

FIG. 22 is a schematic view illustrating an optical path of the head-up display device when viewed from the horizontal direction according to the embodiment of the present disclosure.

FIG. 23 is a schematic view illustrating an optical path of the head-up display device when viewed from the vertical direction according to the embodiment of the present disclosure.

### DESCRIPTION OF EMBODIMENTS

A head-up display device according to an embodiment of the present disclosure will be described with reference to the drawings.

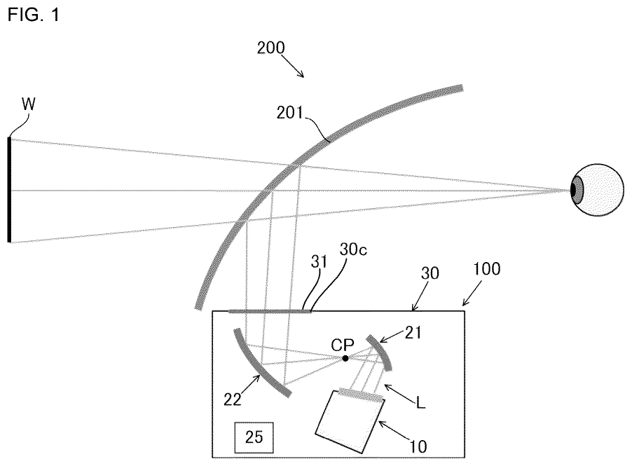

As illustrated in FIG. 1, a head-up display device 100 is installed, for example, in a dashboard of a vehicle 200. The head-up display device 100 emits display light L representing an image toward a windshield 201, which is a projection target member of the vehicle 200, and displays a virtual image W by the display light L reflected by the windshield 201. The virtual image W is displayed in a rectangular display region that is long in the right-left direction and short in the up-down direction when viewed from a viewer.

The head-up display device 100 includes a display device 10, a first mirror 21, a second mirror 22, a control unit 25, and a housing 30.

The housing 30 is formed of a light-shielding resin, metal, or the like in a box shape, and houses the display device 10 and the mirrors 21 and 22. An opening portion 30c is formed in the housing 30 at a position opposed to the windshield 201 in the height direction. The housing 30 includes a window portion 31 that is fitted into the opening portion 30c and is formed in a plate shape made of a translucent resin such as acrylic, through which the display light L passes.

The first mirror 21 and the second mirror 22 configure a relay optical system that guides the display light L from the display device 10 to the windshield 201 while reflecting the display light L.

The first mirror 21 reflects the display light L emitted from the display device 10 toward the second mirror 22. The first mirror 21 is a correction mirror and is a concave mirror that is curved in a concave shape along the height direction of the vehicle and extends linearly along the width direction of the vehicle. The first mirror 21 may be curved in a concave shape or a convex shape in the width direction of the vehicle.

The first mirror 21 reflects the display light L from the display device 10 toward the second mirror 22 so as to cross the display light L at a cross point CP when viewed from the vehicle width direction of the vehicle 200. The cross point CP is located between the first mirror 21 and the second mirror 22 in an optical path of the display light L. The display light L converges from the first mirror 21 to the cross point CP, and diverges from the cross point CP toward the second mirror 22. That is, the display light L forms an image between the first mirror 21 and the second mirror 22 in the height direction.

The second mirror 22 is a concave mirror and reflects the display light L from the display device 10 toward the windshield 201.

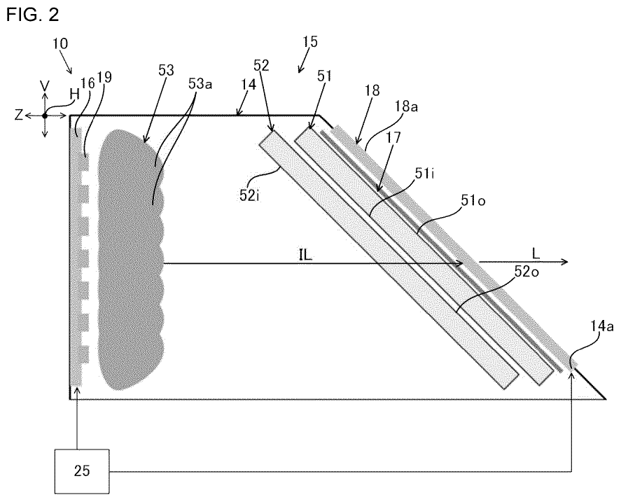

As illustrated in FIG. 2, the display device 10 includes a liquid crystal display panel 18 and an illumination device 15 that illuminates the liquid crystal display panel 18. The illumination device 15 includes a case 14, a substrate 16, a light diffusion member 17, a plurality of light sources 19, and first to third lenses 51 to 53.

In the following description, a horizontal direction H is a direction corresponding to the right-left direction (vehicle width direction) of the virtual image W when viewed from the viewer in terms of an optical path, and a vertical direction V is a direction corresponding to the up-down direction of the virtual image W when viewed from the viewer in terms of an optical path. The horizontal direction H and the vertical direction V are orthogonal to each other, and are also orthogonal to a parallel light traveling direction Z in which illumination light IL collimated by the third lens 53 travels.

The case 14 is formed of a light-shielding resin, metal, or the like in a rectangular tube shape. The substrate 16 and the first to third lenses 51 to 53 are accommodated in the case 14. The liquid crystal display panel 18 is arranged at a position to close an opening portion 14a of the case 14.

The substrate 16 has a plate shape extending along the horizontal direction H and the vertical direction V.

The plurality of light sources 19 are mounted on a surface of the substrate 16, which is opposed to the third lens 53. Each of the light sources 19 is, for example, a light emitting diode (LED). Specifically, the plurality of light sources 19 are arranged in a matrix in the vertical direction V and the horizontal direction H.

The liquid crystal display panel 18 has a display surface 18a that receives the illumination light IL from the light sources 19 via the first to third lenses 51 to 53 and displays an image (intermediate image). The display surface 18a is located on the surface of the liquid crystal display panel 18 on the emission side of the display light L, and has a rectangular shape that is long in the horizontal direction H and short in the vertical direction V. The display light L representing an image is emitted from the display surface 18a of the liquid crystal display panel 18 toward the second mirror 22. The liquid crystal display panel 18 is a thin film transistor (TFT) type liquid crystal panel.

The control unit 25 includes a central processing unit (CPU), a graphics display controller (GDC), a read only memory (ROM), a random access memory (RAM), and the like. The control unit 25 controls the display device 10, for example, the plurality of light sources 19 and the liquid crystal display panel 18.

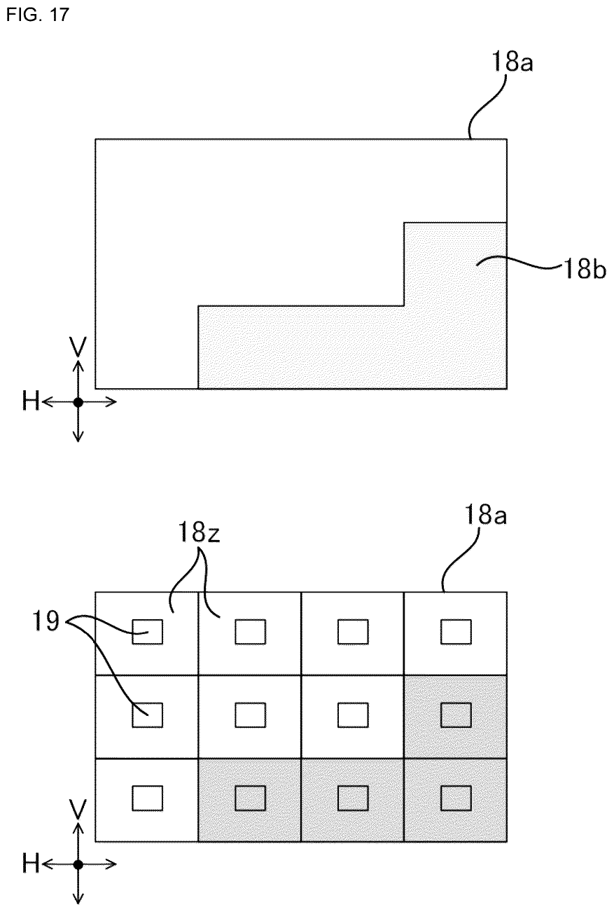

As illustrated in the lower part of FIG. 17, the control unit 25 has a local dimming function of adjusting the brightness for each of a plurality of dimming zones 18z obtained by partitioning the display surface 18a in the vertical direction V and the horizontal direction H in accordance with the content of the image displayed on the display surface 18a. One or more light sources 19 (LEDs) are associated with one dimming zone 18z. The control unit 25 turns on only the dimming zones 18z corresponding to an image display region 18b (refer to the upper part of FIG. 17) in which the content is displayed in the display surface 18a, and turns off the dimming zones 18z other than the image display region 18b in the display surface 18a.

Although the control unit 25 has the local dimming function in the present embodiment, the control unit 25 may turn on or off all the light sources 19 at the same time without having the local dimming function.

As illustrated in FIG. 2, the first to third lenses 51 to 53 are arranged in the order of the third lens 53, the second lens 52, and the first lens 51 from the side closer to the light sources 19. The illumination light IL from the light sources 19 passes through the third lens 53, the second lens 52, and the first lens 51 in this order in the thickness directions thereof.

Each of the first to third lenses 51 to 53 is formed of a transparent optical resin or optical glass, and has a rectangular plate shape that is long in the horizontal direction H and short in the vertical direction V.

The third lens 53 collimates the light emitted from the light sources 19 in the parallel light traveling direction Z. The third lens 53 includes a plurality of convex lens portions 53a. The plurality of convex lens portions 53a are arranged in a matrix so as to correspond to the above-described light sources 19 on a one-to-one basis.

For example, the convex lens portion 53a has a square shape when viewed from the parallel light traveling direction Z, and one side of the square is set to be equal to or less than 6 mm, for example, 5.6 mm.

The third lens 53 is not limited to a lens as long as it is a collimating means, and may be a reflector.

The second lens 52 includes an incident surface 52i on which the illumination light IL that has passed through the third lens 53 is incident, and an emission surface 52o from which the illumination light IL that has passed through the second lens 52 in the thickness direction thereof is emitted.

The first lens 51 includes an incident surface 51i on which the illumination light IL that has passed through the second lens 52 is incident, and an emission surface 51o from which the illumination light IL that has passed through the first lens 51 in the thickness direction thereof is emitted.

In the present example, the first lens 51, the second lens 52, and the liquid crystal display panel 18 are parallel to each other, and are provided in a direction that is inclined and not orthogonal to the parallel light traveling direction Z when viewed from the horizontal direction H.

The emission surface 52o of the second lens 52 is arranged along and to be opposed to the incident surface 51i of the first lens 51.

The emission surface 51o of the first lens 51 is arranged to be opposed to the rear surface of the liquid crystal display panel 18 via the light diffusion member 17.

The light diffusion member 17 is a diffusion plate that diffuses the illumination light IL from the emission surface 51o of the first lens 51 and emits the illumination light IL to the liquid crystal display panel 18. The light diffusion member 17 may be an optical member having a function of diffusing light. For example, the surface of the light diffusion member 17 is formed of a bead member or a fine concave-convex structure, or is formed of a dot sheet or a transmissive milky white sheet.

The first lens 51 and the second lens 52 are provided so as to distribute the illumination light IL in accordance with the display surface 18a and the eyebox of the viewer.

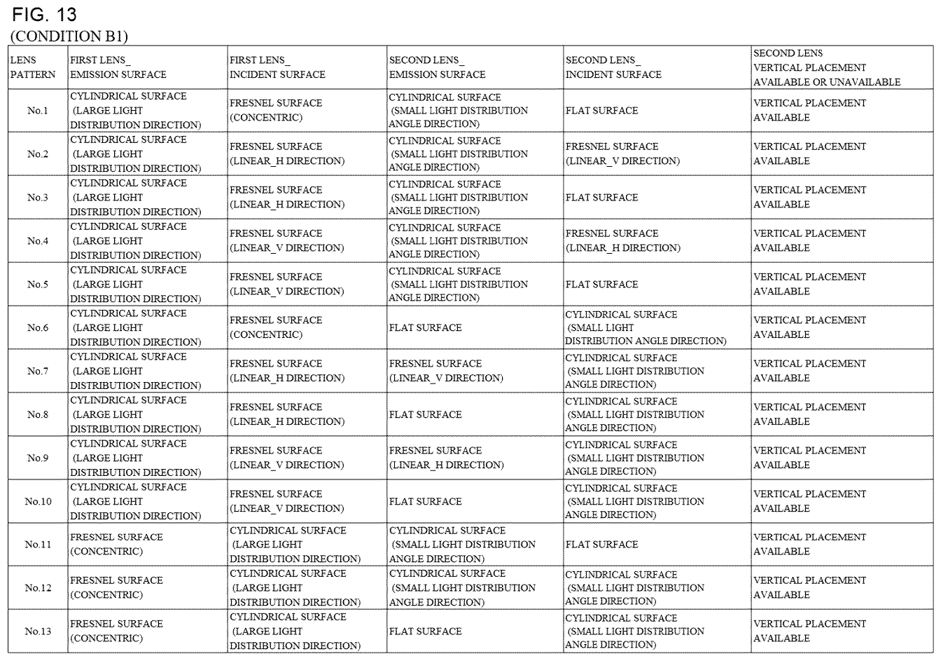

The combination of the types of lenses formed on the surfaces 51i, 51o, 52i, and 52o of the first lens 51 and the second lens 52 is any combination of lens patterns “No. 1” to “No. 31” shown in tables of FIGS. 13 to 16.

In the lens pattern “No. 1” in FIG. 13, the emission surface 51o of the first lens 51 is formed by a cylindrical lens surface Sc (lenticular lens surface) that distributes light in the horizontal direction H, the incident surface 51i of the first lens 51 is formed by a concentric Fresnel lens surface Sf, the emission surface 52o of the second lens 52 is formed by a cylindrical lens surface Sc (lenticular lens surface) that distributes light in the vertical direction V, and the incident surface 52i of the second lens 52 is formed by a flat surface.

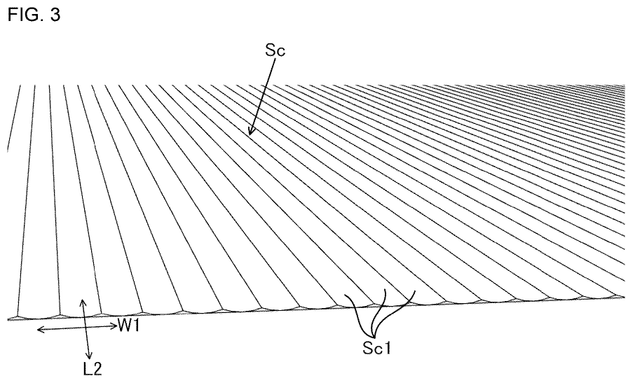

As illustrated in FIG. 3, the cylindrical lens surface Sc includes a plurality of cylindrical lens portions Sc1. Each of the cylindrical lens portions Sc1 is formed in a concave shape extending in an extending direction L2, for example, formed to be recessed in a semicylindrical shape. The plurality of cylindrical lens portions Sc1 are arranged in an arrangement direction W1. On the cylindrical lens surface Sc that distributes light in the horizontal direction H, the horizontal direction H is the arrangement direction W1, and the cylindrical lens portions Sc1 are arranged in the horizontal direction H. On the cylindrical lens surface Sc that distributes light in the vertical direction V, the vertical direction V is the arrangement direction W1, and the cylindrical lens portions Sc1 are arranged in the vertical direction V. In accordance with the horizontal and vertical size of the display surface 18a, the light distribution angle at which the illumination light IL is distributed on the cylindrical lens surface Sc in the horizontal direction H is set to be larger than the light distribution angle at which the illumination light IL is distributed in the vertical direction V. The light distribution angle of the cylindrical lens surface Sc is determined by the curvature of the cylindrical lens portion Sc1.

In the table of FIG. 13, the “cylindrical surface (large light distribution direction)” is the cylindrical lens surface Sc that distributes light in the horizontal direction H, and the “cylindrical surface (small light distribution direction)” is the cylindrical lens surface Sc that distributes light in the vertical direction V.

Although the cylindrical lens portion Sc1 is formed in a concave shape extending in the extending direction L1, the cylindrical lens portion Sc1 may be formed in a semicylindrical convex shape extending in the extending direction L1.

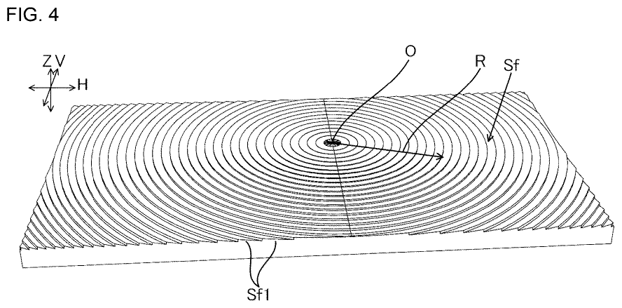

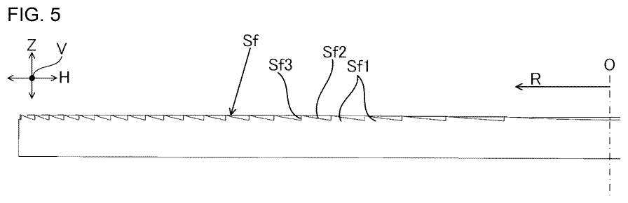

As illustrated in FIGS. 4 and 5, the concentric Fresnel lens surface Sf is formed in a saw-tooth shape in which ridge portions Sf1 are concentrically arranged. Each of the ridge portions Sf1 has a circular shape around a lens eccentric central axis O located on the concentric Fresnel lens surface Sf, and the ridge portions Sf1 are arranged in a radial direction R of the circular shape. The lens eccentric central axis O is provided at a non-central position of the concentric Fresnel lens surface Sf. The eccentric mode of the lens eccentric central axis O will be described in detail below. The lens eccentric central axis O may be provided at the center of the concentric Fresnel lens surface Sf.

The concentric Fresnel lens surface Sf is formed by a concave surface. Specifically, the concentric Fresnel lens surface Sf is formed by dividing a hemispherical concave lens, which is designed to be concave in the vertical direction V and the horizontal direction H, in the radial direction R and arranging the divided parts at the same height, that is, by forming a Fresnel lens. The ridge portion Sf1 includes a side surface Sf3 along the lens eccentric central axis O, and a Fresnel inclined surface Sf2 that is inclined and not orthogonal to the lens eccentric central axis O. The Fresnel inclined surface Sf2 connects the upper end of the side surface Sf3 (the end portion on the light emission side of the concentric Fresnel lens surface Sf) and the lower end of the adjacent side surface Sf3 on the inner side in the radial direction R. The Fresnel inclined surface Sf2 is inclined so as to be closer to the side of the lens eccentric central axis O than a plane orthogonal to the lens eccentric central axis O. The Fresnel inclined surface Sf2 has the same width in the radial direction R. The Fresnel inclined surface Sf2 is a portion that bends light. The Fresnel inclined surface Sf2 may be formed by a curve that faithfully reproduces the lens surface, or may be formed by an approximate curve or a straight line.

In the lens pattern “No. 1,” since the incident surface 52i of the second lens 52 is formed by a flat surface, the illumination light is not bent by the incident surface 52i.

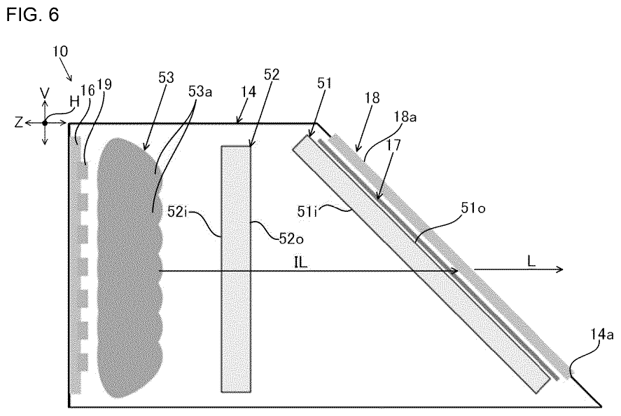

In the embodiment of FIG. 2, the second lens 52 is provided along the first lens 51 and the liquid crystal display panel 18 in a direction inclined to the parallel light traveling direction Z when viewed from the horizontal direction H, but is not limited thereto, and, as illustrated in FIG. 6, the second lens 52 may be provided by vertical placement, that is, provided in a direction orthogonal to the parallel light traveling direction Z.

In the lens pattern “No. 1,” the availability of not only the inclined placement illustrated in FIG. 2 but also the vertical placement is indicated by “vertical placement available” in the column of “second lens vertical placement available or unavailable” on the rightmost side of the table of FIG. 13.

The lens pattern “No. 1” satisfies the following condition A. (Condition A) A Fresnel lens surface (a linear Fresnel lens surface or a concentric Fresnel lens surface) parallel to the display surface 18a is formed on a first surface of any of the surfaces 51i, 51o, 52i, and 52o of the lenses 51 and 52, and a cylindrical lens surface (a lenticular lens surface) or a biconic lens array surface is formed on a second surface of any of the surfaces 51i, 51o, 52i, and 52o.

As long as the condition A is satisfied, the lens pattern is not limited to the lens pattern “No. 1,” and may be any of the lens patterns “No. 1” to “No. 31” shown in the tables of FIGS. 13 to 16. When the condition A is satisfied, the uniformity of the illumination light IL and the display light L can be increased.

Moreover, in the above-described condition A, the lens patterns “No. 1” to “No. 13” of the table of FIG. 13 satisfy the following condition B1. (Condition B1) A Fresnel lens surface (a linear Fresnel lens surface or a concentric Fresnel lens surface) is formed on the incident surface 51i or the emission surface 51o of the first lens 51, and a cylindrical lens surface Sc is formed on the incident surface 52i or the emission surface 52o of the second lens 52.

Hereinafter, the lens patterns “No. 2” to “No. 13” will be described. In the lens pattern “No. 2,” the emission surface 51o of the first lens 51 is formed by a cylindrical lens surface Sc (lenticular lens surface) that distributes light in the horizontal direction H, the incident surface 51i of the first lens 51 is formed by a horizontal light distribution linear Fresnel lens surface SrH, the emission surface 52i of the second lens 52 is formed by a cylindrical lens surface Sc (lenticular lens surface) that distributes light in the vertical direction V, and the incident surface 52i of the second lens 52 is formed by a vertical light distribution linear Fresnel lens surface SrV.

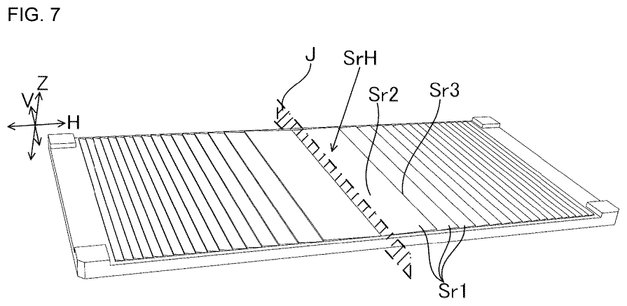

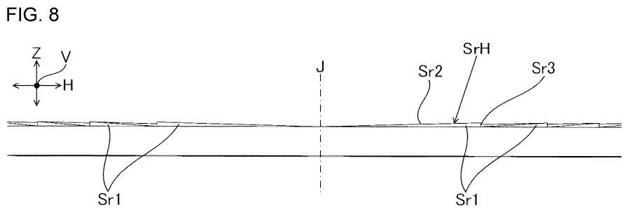

As illustrated in FIGS. 7 and 8, the horizontal light distribution linear Fresnel lens surface SrH is formed in a saw-tooth shape in which ridge portions Sr1 are arranged in the horizontal direction H. Each of the ridge portions Sr1 extends in the vertical direction V. Thus, the horizontal light distribution linear Fresnel lens surface SrH has a curvature of zero in the vertical direction V thereof, and does not bend light in the vertical direction V, but bends light in the horizontal direction H.

The horizontal light distribution linear Fresnel lens surface SrH is formed by a concave surface. Specifically, the horizontal light distribution linear Fresnel lens surface SrH is formed by dividing a concave lens, which is designed to be concave in the horizontal direction H, in the horizontal direction H and arranging the divided parts at the same height, that is, by forming a Fresnel lens. The ridge portion Sr1 includes a side surface Sr3 extending in the vertical direction V and the parallel light traveling direction Z, and a Fresnel inclined surface Sr2 that is inclined and not orthogonal to a center plane J. The Fresnel inclined surface Sr2 is inclined to the horizontal direction H so as to connect the upper end and the lower end of two side surfaces Sr3 adjacent to each other in the horizontal direction H. The Fresnel inclined surface Sr2 is inclined so as to be closer to the side of the center plane J than a plane orthogonal to the center plane J. The Fresnel inclined surfaces Sr2 arranged in the horizontal direction H decrease in width in the horizontal direction H and increase in inclination angle with respect to a reference plane orthogonal to the center plane J as the distance from the center plane J increases in the horizontal direction H.

The Fresnel inclined surface Sr2 is a portion that bends light. The ridge portions Sr1 are formed to be plane-symmetric with respect to the center plane J that is located at the center in the horizontal direction H and extends in the vertical direction V and the parallel light traveling direction Z.

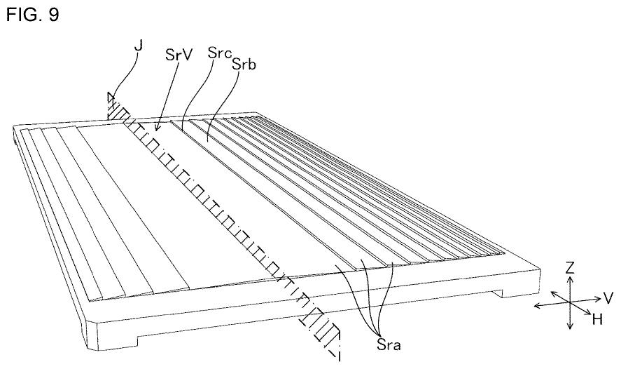

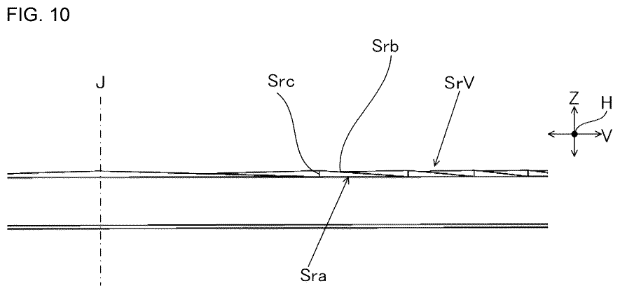

As illustrated in FIGS. 9 and 10, the vertical light distribution linear Fresnel lens surface SrV is formed in a saw-tooth shape in which ridge portions Sra are arranged in the vertical direction V. Each of the ridge portions Sra extends along the horizontal direction H. Thus, the vertical light distribution linear Fresnel lens surface SrV has a curvature of zero in the horizontal direction H thereof, and does not bend light in the horizontal direction H, but bends light in the vertical direction V.

The vertical light distribution linear Fresnel lens surface SrV is formed by a convex surface. Specifically, the vertical light distribution linear Fresnel lens surface SrV is formed by dividing a convex lens, which is designed to be convex in the vertical direction V, in the vertical direction V and arranging the divided parts at the same height, that is, by forming a Fresnel lens. The ridge portion Sra includes a side surface Src extending in the horizontal direction H and the parallel light traveling direction Z, and a Fresnel inclined surface Srb that is inclined and not orthogonal to a center plane J. The Fresnel inclined surface Srb is inclined to the vertical direction V so as to connect the upper end and the lower end of two side surfaces Src adjacent to each other in the vertical direction V. The Fresnel inclined surface Srb is inclined so as to be closer to the side opposite to the center plane J (outward in the vertical direction V) than a plane orthogonal to the center plane J. The Fresnel inclined surfaces Srb arranged in the vertical direction V decrease in width in the vertical direction V and increase in inclination angle with respect to a reference plane orthogonal to the center plane J as the distance from the center plane J increases in the vertical direction V. The Fresnel inclined surface Srb is a portion that bends light. The ridge portions Sra are formed to be plane-symmetric with respect to the center plane J that is located at the center in the vertical direction V and extends in the horizontal direction H and the parallel light traveling direction Z.

In the lens pattern “No. 3” of the table of FIG. 13, the emission surface 51o of the first lens 51 is formed by a cylindrical lens surface Sc (lenticular lens surface) that distributes light in the horizontal direction H, the incident surface 51i of the first lens 51 is formed by a horizontal light distribution linear Fresnel lens surface SrH, the emission surface 52o of the second lens 52 is formed by a cylindrical lens surface Sc (lenticular lens surface) that distributes light in the vertical direction V, and the incident surface 52i of the second lens 52 is formed by a flat surface.

In the lens pattern “No. 4,” the emission surface 51o of the first lens 51 is formed by a cylindrical lens surface Sc (lenticular lens surface) that distributes light in the horizontal direction H, the incident surface 51i of the first lens 51 is formed by a vertical light distribution linear Fresnel lens surface SrV, the emission surface 52o of the second lens 52 is formed by a cylindrical lens surface Sc (lenticular lens surface) that distributes light in the vertical direction V, and the incident surface 52i of the second lens 52 is formed by a horizontal light distribution linear Fresnel lens surface SrH.

In the lens pattern “No. 5,” the emission surface 51o of the first lens 51 is formed by a cylindrical lens surface Sc (lenticular lens surface) that distributes light in the horizontal direction H, the incident surface 51i of the first lens 51 is formed by a vertical light distribution linear Fresnel lens surface SrV, the emission surface 52o of the second lens 52 is formed by a cylindrical lens surface Sc (lenticular lens surface) that distributes light in the vertical direction V, and the incident surface 52i of the second lens 52 is formed by a flat surface.

In the lens pattern “No. 6,” the emission surface 51o of the first lens 51 is formed by a cylindrical lens surface Sc (lenticular lens surface) that distributes light in the horizontal direction H, the incident surface 51i of the first lens 51 is formed by a concentric Fresnel lens surface Sf, the emission surface 52o of the second lens 52 is formed by a flat surface, and the incident surface 52i of the second lens 52 is formed by a cylindrical lens surface Sc (lenticular lens surface) that distributes light in the vertical direction V.

In the lens pattern “No. 7,” the emission surface 51o of the first lens 51 is formed by a cylindrical lens surface Sc (lenticular lens surface) that distributes light in the horizontal direction H, the incident surface 51i of the first lens 51 is formed by a horizontal light distribution linear Fresnel lens surface SrH, the emission surface 52o of the second lens 52 is formed by a vertical light distribution linear Fresnel lens surface SrV, and the incident surface 52i of the second lens 52 is formed by a cylindrical lens surface Sc (lenticular lens surface) that distributes light in the vertical direction V.

In the lens pattern “No. 8,” the emission surface 51o of the first lens 51 is formed by a cylindrical lens surface Sc (lenticular lens surface) that distributes light in the horizontal direction H, the incident surface 51i of the first lens 51 is formed by a horizontal light distribution linear Fresnel lens surface SrH, the emission surface 52o of the second lens 52 is formed by a flat surface, and the incident surface 52i of the second lens 52 is formed by a cylindrical lens surface Sc (lenticular lens surface) that distributes light in the vertical direction V.

In the lens pattern “No. 9,” the emission surface 51o of the first lens 51 is formed by a cylindrical lens surface Sc (lenticular lens surface) that distributes light in the horizontal direction H, the incident surface 51i of the first lens 51 is formed by a vertical light distribution linear Fresnel lens surface SrV, the emission surface 52o of the second lens 52 is formed by a horizontal light distribution linear Fresnel lens surface SrH, and the incident surface 52i of the second lens 52 is formed by a cylindrical lens surface Sc (lenticular lens surface) that distributes light in the vertical direction V.

In the lens pattern “No. 10,” the emission surface 51o of the first lens 51 is formed by a cylindrical lens surface Sc (lenticular lens surface) that distributes light in the horizontal direction H, the incident surface 51i of the first lens 51 is formed by a vertical light distribution linear Fresnel lens surface SrV, the emission surface 52o of the second lens 52 is formed by a flat surface, and the incident surface 52i of the second lens 52 is formed by a cylindrical lens surface Sc (lenticular lens surface) that distributes light in the vertical direction V.

In the lens pattern “No. 11,” the emission surface 51o of the first lens 51 is formed by a concentric Fresnel lens surface Sf, the incident surface 51i of the first lens 51 is formed by a cylindrical lens surface Sc (lenticular lens surface) that distributes light in the horizontal direction H, the emission surface 52o of the second lens 52 is formed by a cylindrical lens surface Sc (lenticular lens surface) that distributes light in the vertical direction V, and the incident surface 52i of the second lens 52 is formed by a flat surface.

In the lens pattern “No. 12,” the emission surface 51o of the first lens 51 is formed by a concentric Fresnel lens surface Sf, the incident surface 51i of the first lens 51 is formed by a cylindrical lens surface Sc (lenticular lens surface) that distributes light in the horizontal direction H, and each of the emission surface 52o and the incident surface 52i of the second lens 52 is formed by a cylindrical lens surface Sc (lenticular lens surface) that distributes light in the vertical direction V.

In the lens pattern “No. 13,” the emission surface 51o of the first lens 51 is formed by a concentric Fresnel lens surface Sf, the incident surface 51i of the first lens 51 is formed by a cylindrical lens surface Sc (lenticular lens surface) that distributes light in the horizontal direction H, the emission surface 52o of the second lens 52 is formed by a flat surface, and the incident surface 52i of the second lens 52 is formed by a cylindrical lens surface Sc (lenticular lens surface) that distributes light in the vertical direction V.

For the second lens 52, both the vertical placement illustrated in FIG. 6 and the inclined placement illustrated in FIG. 2 are available in the lens patterns “No. 1” to “No. 14,” and the vertical placement is unavailable (inappropriate) and only the inclined placement is available (appropriate) in the lens patterns “No. 15” to “No. 31.”

Furthermore, when the following condition B1-1 is satisfied in the condition B1, the uniformity of the illumination light IL and the display light L is further improved.

(Condition B1-1) The second lens 52 is vertically placed (refer to FIG. 6), and a cylindrical lens surface Sc that distributes light in the vertical direction V is formed on the incident surface 52i or the emission surface 52o of the second lens 52.

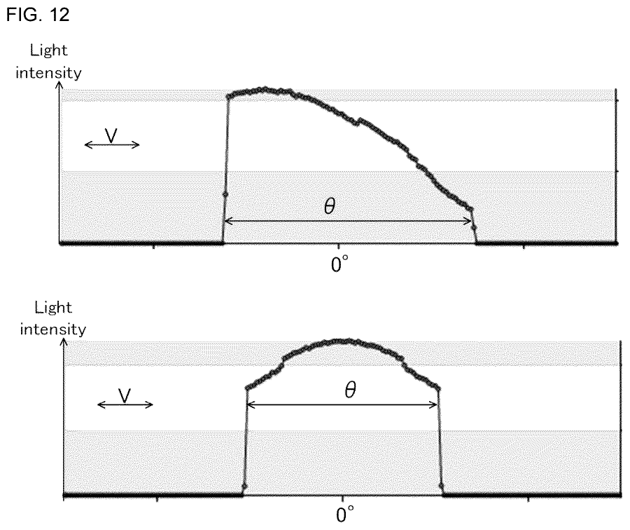

In the configuration in which the cylindrical lens surface Sc that distributes light in the vertical direction V is parallel to the display surface 18a (the inclined placement configuration that does not satisfy the condition B1-1), as illustrated in the upper part of FIG. 12, the light distribution angle θ of the illumination light IL or the display light L is widened, and the light intensity distribution is biased to one side in the vertical direction V. In this regard, in the configuration in which the cylindrical lens surface Sc that distributes light in the vertical direction V is orthogonal to the parallel light traveling direction Z (the vertical placement configuration that satisfies the condition B1-1), as illustrated in the lower part of FIG. 12, the light distribution angle θ of the illumination light IL or the display light L is not widened, and the light intensity distribution is not biased. Thus, the uniformity is increased, and the light efficiency is also increased. Therefore, the cylindrical lens surface Sc that distributes light in the vertical direction V is preferably orthogonal to an optical axis of the illumination light IL from the light sources 19.

The upper part of FIG. 12 illustrates the light intensity distribution when the cylindrical lens surface Sc that distributes light in the vertical direction V is inclined by 30° with respect to an angle orthogonal to the parallel light traveling direction Z. It is known that the larger the inclination is, the larger the bias of the light intensity distribution is. Even when the second lens 52 is placed to be inclined (refer to FIG. 2) such that the cylindrical lens surface Sc that distributes light in the vertical direction V is parallel to the display surface 18a, an equivalent light distribution angle can be obtained by reducing the curvature (increasing the curvature radius) of each of the cylindrical lens portions Sc1.

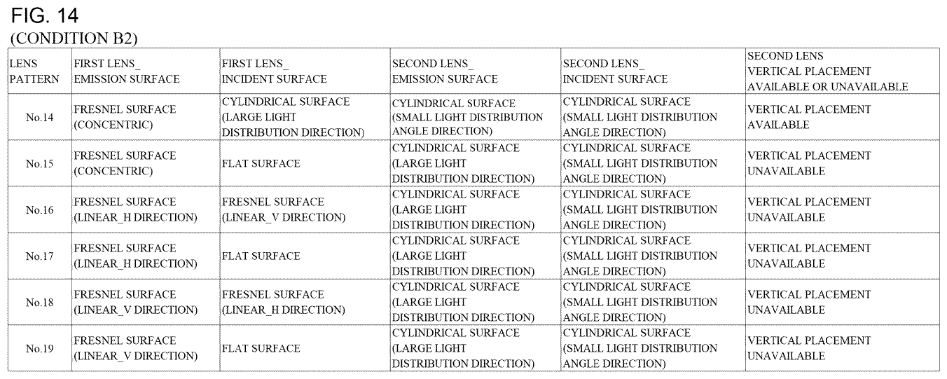

Moreover, in the above-described condition A, the lens patterns “No. 14” to “No. 19” of the table of FIG. 14 satisfy the following condition B2. (Condition B2) A Fresnel lens surface (a linear Fresnel lens surface or a concentric Fresnel lens surface) is formed on the incident surface 51i or the emission surface 51o of the first lens 51, and cylindrical lens surfaces Sc are formed on both the incident surface 52i and the emission surface 52o of the second lens 52.

Since both surfaces of the second lens 52 are formed as the cylindrical lens surfaces Sc in the condition B2, the structure of the second lens 52 is simplified.

In the lens pattern “No. 14,” the emission surface 51o of the first lens 51 is formed by a concentric Fresnel lens surface Sf, the incident surface 51i of the first lens 51 is formed by a cylindrical lens surface Sc (lenticular lens surface) that distributes light in the horizontal direction H, and each of the emission surface 52o and the incident surface 52i of the second lens 52 is formed by a cylindrical lens surface Sc (lenticular lens surface) that distributes light in the vertical direction V.

In the lens pattern “No. 15,” the emission surface 51o of the first lens 51 is formed by a concentric Fresnel lens surface Sf, the incident surface 51i of the first lens 51 is formed by a flat surface, the emission surface 52o of the second lens 52 is formed by a cylindrical lens surface Sc (lenticular lens surface) that distributes light in the horizontal direction H, and the incident surface 52i of the second lens 52 is formed by a cylindrical lens surface Sc (lenticular lens surface) that distributes light in the vertical direction V.

In the lens pattern “No. 16,” the emission surface 51o of the first lens 51 is formed by a horizontal light distribution linear Fresnel lens surface SrH, the incident surface 51i of the first lens 51 is formed by a vertical light distribution linear Fresnel lens surface SrV, the emission surface 52o of the second lens 52 is formed by a cylindrical lens surface Sc (lenticular lens surface) that distributes light in the horizontal direction H, and the incident surface 52i of the second lens 52 is formed by a cylindrical lens surface Sc (lenticular lens surface) that distributes light in the vertical direction V.

In the lens pattern “No. 17,” the emission surface 51o of the first lens 51 is formed by a horizontal light distribution linear Fresnel lens surface SrH, the incident surface 51i of the first lens 51 is formed by a flat surface, the emission surface 52o of the second lens 52 is formed by a cylindrical lens surface Sc (lenticular lens surface) that distributes light in the horizontal direction H, and the incident surface 52i of the second lens 52 is formed by a cylindrical lens surface Sc (lenticular lens surface) that distributes light in the vertical direction V.

In the lens pattern “No. 18,” the emission surface 51o of the first lens 51 is formed by a vertical light distribution linear Fresnel lens surface SrV, the incident surface 51i of the first lens 51 is formed by a horizontal light distribution linear Fresnel lens surface SrH, the emission surface 52o of the second lens 52 is formed by a cylindrical lens surface Sc (lenticular lens surface) that distributes light in the horizontal direction H, and the incident surface 52i of the second lens 52 is formed by a cylindrical lens surface Sc (lenticular lens surface) that distributes light in the vertical direction V.

In the lens pattern “No. 19,” the emission surface 51o of the first lens 51 is formed by a vertical light distribution linear Fresnel lens surface SrV, the incident surface 51i of the first lens 51 is formed by a flat surface, the emission surface 52o of the second lens 52 is formed by a cylindrical lens surface Sc (lenticular lens surface) that distributes light in the horizontal direction H, and the incident surface 52i of the second lens 52 is formed by a cylindrical lens surface Sc (lenticular lens surface) that distributes light in the vertical direction V.

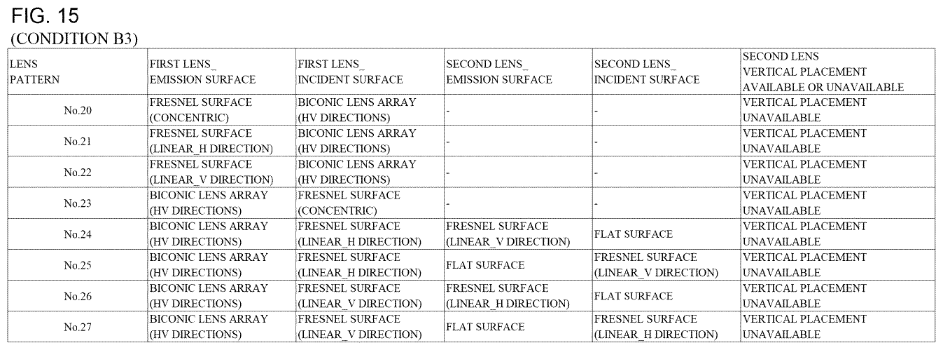

Moreover, in the above-described condition A, the lens patterns “No. 20” to “No. 27” of the table of FIG. 15 satisfy the following condition B3. (Condition B3) A Fresnel lens surface (a linear Fresnel lens surface or a concentric Fresnel lens surface) is formed on one of the incident surface 51i and the emission surface 51o of the first lens 51, and a biconic lens array surface is formed on the other of the incident surface 51i and the emission surface 51o.

According to the condition B3, since the biconic lens array surface that distributes the illumination light IL in both the vertical direction V and the horizontal direction H is adopted, a lens is easily omitted or a flat surface is easily added to any one of the surfaces 51i, 51o, 52i, and 52o, and the degree of freedom in lens design is increased.

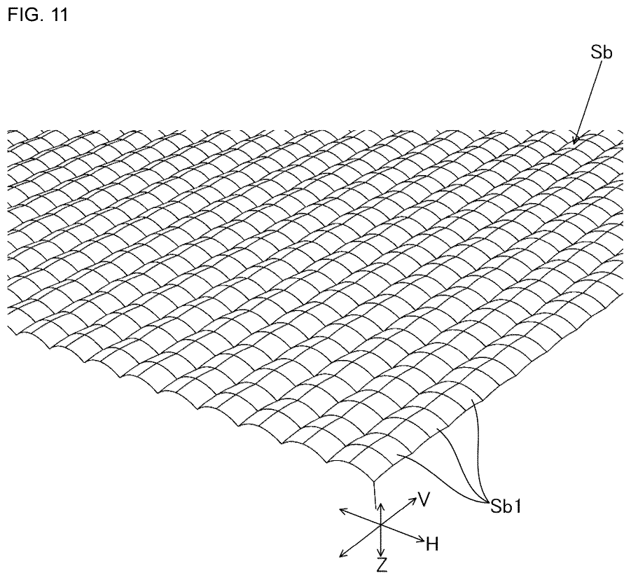

As illustrated in FIG. 11, a biconic lens array surface Sb has a plurality of microlens portions Sb1 arranged in the vertical direction V and the horizontal direction H. Each of the microlens portions Sb1 is formed to have a convex shape. Each of the microlens portions Sb1 is curved in a convex shape when viewed from the X direction, and is curved in a convex shape when viewed from the Y direction. For each of the microlens portions Sb1, a conic coefficient kx in the X direction and a conic coefficient ky in the Y direction are set. The conic coefficients kx and ky of each of the microlens portions Sb1 can take any real number. That is, both of the conic coefficients kx and ky may be zero.

The biconic lens array surface Sb has both functions of the cylindrical lens surface Sc that distributes light in the horizontal direction H and the cylindrical lens surface Sc that distributes light in the vertical direction V, that is, a function of refracting or diffusing light in the vertical direction V and the horizontal direction H.

Each of the microlens portions Sb1 may be formed to have a concave shape.

In the lens patterns “No. 20” to “No. 23” of the table of FIG. 15, the second lens 52 is omitted, and the display device includes only the first lens 51 and the third lens 53 as lenses. Therefore, a simple configuration can be realized.

In the lens pattern “No. 20,” the emission surface 51o of the first lens 51 is formed by a concentric Fresnel lens surface Sf, and the incident surface 51i of the first lens 51 is formed by a biconic lens array surface Sb.

In the lens pattern “No. 21,” the emission surface 51o of the first lens 51 is formed by a horizontal light distribution linear Fresnel lens surface SrH, and the incident surface 51i of the first lens 51 is formed by a biconic lens array surface Sb.

In the lens pattern “No. 22,” the emission surface 51o of the first lens 51 is formed by a vertical light distribution linear Fresnel lens surface SrV, and the incident surface 51i of the first lens 51 is formed by a biconic lens array surface Sb.

In the lens pattern “No. 23,” the emission surface 51o of the first lens 51 is formed by a biconic lens array surface Sb, and the incident surface 51i of the first lens 51 is formed by a concentric Fresnel lens surface Sf.

In the lens pattern “No. 24,” the emission surface 51o of the first lens 51 is formed by a biconic lens array surface Sb, the incident surface 51i of the first lens 51 is formed by a horizontal light distribution linear Fresnel lens surface SrH, the emission surface 52o of the second lens 52 is formed by a vertical light distribution linear Fresnel lens surface SrV, and the incident surface 52i of the second lens 52 is formed by a flat surface.

In the lens pattern “No. 25,” the emission surface 51o of the first lens 51 is formed by a biconic lens array surface Sb, the incident surface 51i of the first lens 51 is formed by a horizontal light distribution linear Fresnel lens surface SrH, the emission surface 52o of the second lens 52 is formed by a flat surface, and the incident surface 52i of the second lens 52 is formed by a vertical light distribution linear Fresnel lens surface SrV.

In the lens pattern “No. 26,” the emission surface 51o of the first lens 51 is formed by a biconic lens array surface Sb, the incident surface 51i of the first lens 51 is formed by a vertical light distribution linear Fresnel lens surface SrV, the emission surface 52o of the second lens 52 is formed by a horizontal light distribution linear Fresnel lens surface SrH, and the incident surface 52i of the second lens 52 is formed by a flat surface.

In the lens pattern “No. 27,” the emission surface 51o of the first lens 51 is formed by a biconic lens array surface Sb, the incident surface 51i of the first lens 51 is formed by a vertical light distribution linear Fresnel lens surface SrV, the emission surface 52o of the second lens 52 is formed by a flat surface, and the incident surface 52i of the second lens 52 is formed by a horizontal light distribution linear Fresnel lens surface SrH.

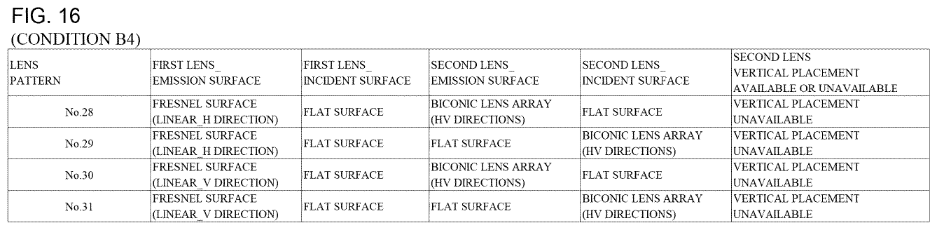

Moreover, in the above-described condition A, the lens patterns “No. 28” to “No. 31” of the table of FIG. 16 satisfy the following condition B4. (Condition B4) A Fresnel lens surface (a linear Fresnel lens surface or a concentric Fresnel lens surface) is formed on one of the incident surface 51i and the emission surface 51o of the first lens 51, and a biconic lens array surface Sb is formed on one of the incident surface 52i and the emission surface 52o of the second lens 52.

In the lens pattern “No. 28,” the emission surface 51o of the first lens 51 is formed by a horizontal light distribution linear Fresnel lens surface SrH, the incident surface 51i of the first lens 51 is formed by a flat surface, the emission surface 52o of the second lens 52 is formed by a biconic lens array surface Sb, and the incident surface 52i of the second lens 52 is formed by a flat surface.

In the lens pattern “No. 29,” the emission surface 51o of the first lens 51 is formed by a horizontal light distribution linear Fresnel lens surface SrH, the incident surface 51i of the first lens 51 is formed by a flat surface, the emission surface 52o of the second lens 52 is formed by a flat surface, and the incident surface 52i of the second lens 52 is formed by a biconic lens array surface Sb.

In the lens pattern “No. 30,” the emission surface 51o of the first lens 51 is formed by a vertical light distribution linear Fresnel lens surface SrV, the incident surface 51i of the first lens 51 is formed by a flat surface, the emission surface 52o of the second lens 52 is formed by a biconic lens array surface Sb, and the incident surface 52i of the second lens 52 is formed by a flat surface.

In the lens pattern “No. 31,” the emission surface 51o of the first lens 51 is formed by a vertical light distribution linear Fresnel lens surface SrV, the incident surface 51i of the first lens 51 is formed by a flat surface, the emission surface 52o of the second lens 52 is formed by a flat surface, and the incident surface 52i of the second lens 52 is formed by a biconic lens array surface Sb.

In any of the lens patterns “No. 28” to “No. 31” described above, the incident surface 51i of the first lens 51 is formed by a flat surface. When a periodic structure such as a Fresnel lens or a lenticular lens is present on each of two surfaces which are in contact with each other or opposed to each other, interference fringes of light may be generated. However, by interposing the flat surface, a distance between the periodic structures can be maintained, and the generation of interference fringes of light can be suppressed. As described above, by adopting the biconic lens array surface Sb capable of distributing light in two directions, i.e., the vertical direction V and the horizontal direction H, there is a margin for providing a flat surface for suppressing the generation of interference fringes of light.

Moreover, in the above-described condition A, the lens patterns “No. 2” to “No. 5,” “No. 7” to “No. 10,” “No. 16” to “No. 19,” “No. 21,” “No. 22,” and “No. 24” to “No. 31” satisfy the following condition C.

(Condition C) In a cross optical system in which the display light L reflected by the first mirror 21 does not cross in the horizontal direction H but crosses in the vertical direction V at the cross point CP, one or more of the surfaces 51i, 51o, 52i, and 52o are the linear Fresnel lens surface(s) SrH and/or SrV.

Furthermore, in the above-described condition C, each of the patterns having both the linear Fresnel lens surfaces SrH and SrV satisfies the following conditions C1 and C2.

(Condition C1) The horizontal light distribution linear Fresnel lens surface SrH is formed by a concave surface (refer to FIG. 8).

(Condition C2) The vertical light distribution linear Fresnel lens surface SrV is formed by a convex surface (refer to FIG. 10). The condition C2 makes it easy for the display light L to cross in the vertical direction V and makes it difficult for the display light L to cross in the horizontal direction H, which is suitable for the above-described cross optical system.

Furthermore, in the above-described condition C, the lens patterns “No. 2,” “No. 4,” “No. 7,” “No. 9,” “No. 16,” “No. 18,” and “No. 24” to “No. 27” having a plurality of linear Fresnel lens surfaces preferably satisfy the following condition D. (Condition D) When two or more linear Fresnel lens surfaces are provided, the absolute value of the curvature of the linear Fresnel lens surface closer to the display surface 18a is set to be equal to or more than the absolute value of the curvature of the linear Fresnel lens surface farther from the display surface 18a.

A large curvature means that the degree of curve is sharp and the curvature radius is small.

In addition, the order is the emission surface 51o, the incident surface 51i, the emission surface 52o, and the incident surface 52i from the side closer to the display surface 18a.

The curvatures of the linear Fresnel lens surfaces SrH and SrV are curvatures before forming Fresnel lenses when the Fresnel inclined surfaces

Sr2 and Srb arranged in a direction away from the center plane J are arranged on the same curved surface, and the larger the curvatures are, the stronger the property of bending light is.

If the linear Fresnel lens surfaces SrH and SrV that strongly bend light are arranged far from the display surface 18a, the light is excessively bent in the optical path length from the linear Fresnel lens surfaces SrH and SrV to the display surface 18a, and the uniformity may be reduced. In order to suppress the reduction in the uniformity, the above-described condition D is set.

For example, in the lens pattern “No. 2,” the absolute value of the curvature of the concave surface of the horizontal light distribution linear Fresnel lens surface SrH of the incident surface 51i is set to be equal to or more than the absolute value of the curvature of the convex surface of the vertical light distribution linear Fresnel lens surface SrV of the incident surface 52i.

Furthermore, in the above-described condition D, the following condition E is preferably satisfied.

(Condition E) The linear Fresnel lens surface SrH or SrV is formed on the emission surface 51o of the first lens 51.

The condition E can make the curvature of the linear Fresnel lens surface SrH or SrV formed on the emission surface 51o of the first lens 51 smaller, and the illumination efficiency of the illumination light IL is increased.

Moreover, in the above-described condition A, the lens patterns “No. 1” to “No. 19” preferably satisfy the following condition F.

(Condition F) When two or more cylindrical lens surfaces are provided, the absolute value of the curvature of the cylindrical lens surface closer to the display surface 18a is set to be equal to or more than the absolute value of the curvature of the cylindrical lens surface farther from the display surface 18a.

The curvature of the cylindrical lens surface Sc is the curvature of the cylindrical lens portion Sc1.

The larger the curvature of the cylindrical lens surface Sc is, the stronger the property of bending light is.

If the cylindrical lens surface Sc that strongly bends light is arranged far from the display surface 18a, the light is excessively bent in the optical path length from the cylindrical lens surface Sc to the display surface 18a, and the uniformity may be reduced. In order to suppress the reduction in the uniformity, the above-described condition F is set. In particular, there is a case where only a part of the display surface 18a (dimming zone 18z) is illuminated by the local dimming function, and in this case, in particular, a gap between the dimming zone 18z and the actual illumination range is easily-noticeable. Therefore, it is important to suppress the gap by setting the above-described condition F.

Moreover, in the above-described condition A, the lens patterns “No. 11” to “No. 15” and “No. 20” satisfy the following condition G.

(Condition G) The emission surface 51o of the first lens 51 is formed by a concentric Fresnel lens surface Sf.

The condition G can make the curvature of the concentric Fresnel lens surface Sf formed on the emission surface 51o of the first lens 51 smaller, and the illumination efficiency of the illumination light IL is increased.

Furthermore, in the above-described condition G, the following condition G1 is satisfied in the present embodiment.

(Condition G1) The concentric Fresnel lens surface Sf is formed by a concave surface (refer to FIG. 5).

The concentric Fresnel lens surface Sf being formed by a concave surface means that, before forming a Fresnel lens, the Fresnel inclined surfaces Sf2 arranged in the radial direction R are arranged on the same curved surface to form a hemispherical concave shape.

Furthermore, the following conditions l to M are satisfied in the present embodiment.

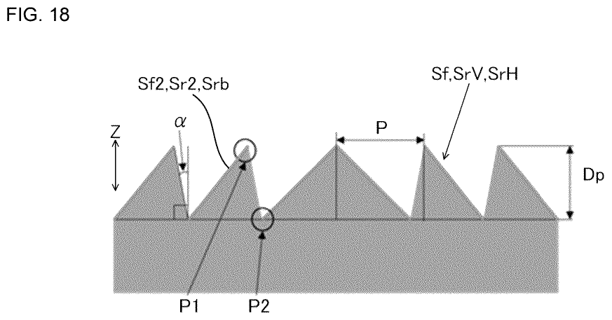

(Condition l) A depth Dp of the Fresnel lens surface Sf, SrV, or SrH is uniform in the surface (refer to FIG. 18).

(Condition J) The depth Dp is equal to or less than 0.1 mm, for example, 0.1 mm or 0.02 mm.

(Condition K) An angle α (draft angle) of the side surface Sf3, Sr3, or Src with respect to the parallel light traveling direction Z is 0 to 5 degrees, for example, 1 degree. The smaller the angle α is, the larger the area of the

Fresnel inclined surface Sf2, Sr2, or Srb can be, and thus the higher the illumination efficiency is.

(Condition L) The sum of the curvature radius of a tip portion P1 and the curvature radius of a root portion P2 of the Fresnel lens surface Sf, SrV, or SrH is more than 0% and equal to or less than 15%, for example, equal to or less than 12.5% of a lens pitch P of the Fresnel lens surface Sf, SrV, or SrH. The smaller the sum is, the larger the area of the Fresnel inclined surface Sf2, Sr2, or Srb can be, and thus the higher the illumination efficiency is.

(Condition M) The lens pitch P of the cylindrical lens surface Sc or the biconic lens array surface Sb is equal to or less than 0.3 mm. The lens pitch P is preferably set to such a value from the viewpoint of the formability and the stripe visibility of the lens.

The Fresnel lens is illustrated as a convex surface in FIG. 18, but the same is true in a concave surface.

In addition, the relationship between a curvature C1 of the inclined Fresnel lens surface when the Fresnel lens surface Sf, SrH, or SrV is arranged to be not orthogonal to and be inclined to the parallel light traveling direction Z, a curvature C2 of the vertical Fresnel lens surface when the Fresnel lens surface Sf, SrH, or SrV is arranged to be orthogonal to the parallel light traveling direction Z, and a curvature C3 of a vertical toroidal surface when a toroidal surface described in Patent Document 1 is arranged to be orthogonal to the parallel light traveling direction Z is as follows:

the curvature C1 of the inclined Fresnel lens surface <the curvature C2 of the vertical Fresnel lens surface <the curvature C3 of the vertical toroidal surface.

As a distance between the display surface 18a and the Fresnel lens surface or the toroidal surface becomes smaller, the curvature can be made smaller, so that the curvature C1 of the inclined Fresnel lens surface can be made the smallest. Moreover, unlike the toroidal surface, the Fresnel lens surface has the same position in the parallel light traveling direction Z at the edge and the center, so that the center and the edge can be brought closer to the display surface 18a than in the case of the toroidal surface. Therefore, the curvature C2 of the vertical Fresnel lens surface can be smaller than the curvature C3 of the vertical toroidal surface.

### Effects

According to the embodiments described above, the following effects are achieved.

(1) A display device 10 that emits display light L representing an image, includes: a light source 19 that emits illumination light IL; a third lens 53 as an example of a collimating means for collimating the illumination light IL from the light source 19; surfaces 51i, 51o, 52i, and 52o as examples of a plurality of light distribution optical surfaces that distribute the illumination light IL collimated by the third lens 53 and are arranged on an optical axis of the collimated illumination light IL; and a display surface 18a that receives the illumination light IL distributed by the surfaces 51i, 51i, 52i, and 52o to emit the display light L and is provided in a direction inclined with respect to an optical axis of the emitted display light L. A first light distribution optical surface of any of the surfaces 51i, 51o, 52i, and 52o is a Fresnel lens surface Sf, SrH, or SrV provided in a direction along the display surface 18a. A second light distribution optical surface of any of the surfaces 51i, 51o, 52i, and 52o is a cylindrical lens surface Sc (lenticular lens surface) or a biconic lens array surface Sb.

According to this configuration, the uniformity of the illumination light IL and the display light L can be increased by the combination of the Fresnel lens surface Sf, SrH, or SrV and the cylindrical lens surface Sc or the biconic lens array surface Sb.

Specifically, in the configuration of Patent Document 1, there is room for improvement from the viewpoint of the uniformity for the following reasons (a) to (c).

(a) Since the emission surface of the lens is a large toroidal surface, the illumination shape is distorted at the end portion of the liquid crystal display panel due to the aberration.

(b) Since each lens surface that generates diverging light is far from the liquid crystal display panel, the optical path length is increased, and as a result, the illumination shape is widely extended.

(c) Since the liquid crystal display panel is inclined with respect to a backlight, a difference in the distance occurs between the upper and lower portions of the liquid crystal display panel, and the amount of illumination extension changes.

In the point (a), since the Fresnel lens surface Sf, SrH, or SrV is provided instead of the toroidal surface in the above configuration, the distortion of the illumination shape due to the shape of the toroidal surface is suppressed.

In the point (b), since the Fresnel lens surface Sf, SrH, or SrV is arranged to be inclined along the display surface 18a in the above configuration, the optical path length is unlikely to be increased, and the illumination shape is prevented from being widely extended.

In the point (c), since the Fresnel lens surface Sf, SrH, or SrV is arranged to be inclined along the display surface 18a in the above configuration, a change in the amount of illumination extension due to a difference in the distance between the display surface 18a and the light source 19 is suppressed.

(2) The second light distribution optical surface is one of two second light distribution optical surfaces, and one of the two second light distribution optical surfaces is a cylindrical lens surface Sc as an example of a first lenticular lens surface that distributes light in a vertical direction V. The other of the two second light distribution optical surfaces is a cylindrical lens surface Sc as an example of a second lenticular lens surface that distributes light in a horizontal direction H. The cylindrical lens surface Sc that distributes light in the vertical direction V is arranged to be orthogonal to the optical axis of the collimated illumination light IL. The vertical direction V and the horizontal direction H are set to be orthogonal to the optical axis and in directions orthogonal to each other.

According to this configuration, as described with reference to FIG. 12, the intensity distribution of the illumination light IL and the display light L is unlikely to be biased, the uniformity of the illumination light IL and the display light L is increased, and the light efficiency is also increased.

(3) The second light distribution optical surface is one of two second light distribution optical surfaces, and an absolute value of a curvature radius of a cylindrical lens surface Sc as an example of a first lenticular lens surface that is one of the two second light distribution optical surfaces is set to be equal to or more than an absolute value of a curvature radius of a cylindrical lens surface Sc as an example of a second lenticular lens surface that is the other of the two second light distribution optical surfaces, which is located farther from the display surface 18a than the cylindrical lens surface Sc (the first lenticular lens surface).

According to this configuration, by arranging one of the two cylindrical lens surfaces Sc, which has a stronger property of bending light, closer to the display surface 18a, a reduction in the uniformity due to excessive bending of light is suppressed in the optical path length from the cylindrical lens surface Sc, which has a stronger property of bending light, to the display surface 18a.

(4) A head-up display device 100 includes: the display device 10; and a first mirror 21 as an example of a mirror that reflects the display light L from the display device 10. The first mirror 21 reflects the display light L so as to cross the upper end and the lower end of the display light L, which are both ends in the vertical direction V.

The Fresnel lens surface as the first light distribution optical surface is a vertical light distribution linear Fresnel lens surface SrV obtained by forming a Fresnel lens from a convex lens that extends linearly with a curvature of zero in the horizontal direction H and has a convex shape in the vertical direction V.

According to this configuration, in the cross optical system in which the display light L crosses in the vertical direction V, the vertical light distribution linear Fresnel lens surface SrV having a convex shape in the vertical direction V in which the illumination light IL is unlikely to diverge due to the crossing of the display light L is preferable.

The present disclosure is not limited by the above embodiments and drawings. Changes (including deletion of components) can be made as appropriate without departing from the scope of the present disclosure. Examples of modifications will be described below.

### Modifications

In the above embodiments, the head-up display device 100 is configured as a cross optical system in which the display light L reflected by the first mirror 21 does not cross in the horizontal direction H but crosses in the vertical direction V at the cross point CP. However, the head-up display device 100 may be configured as a non-cross optical system without being limited to the cross optical system.

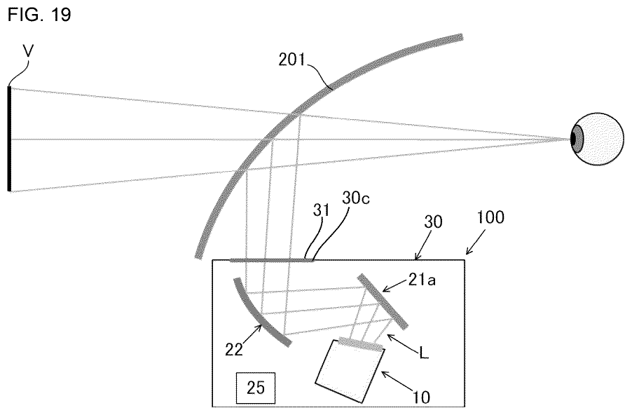

In the case of the non-cross optical system, as illustrated in FIG. 19, a first mirror 21a may be formed of a flat mirror such that the display light L reflected by the first mirror 21a does not cross in the vertical direction V and the horizontal direction H. In addition, the first mirror 21a may be a convex mirror without being limited to the flat mirror. Moreover, the first mirrors 21 and 21a may be omitted, and the display light L may be directly projected to the second mirror 22 from the display device 10. In the non-cross optical system, the display light L does not need to cross in the vertical direction V, and the vertical light distribution linear Fresnel lens surface SrV does not need to be formed by a convex surface (forming a Fresnel lens from a convex lens). Thus, the concave concentric Fresnel lens surface Sf obtained by forming a Fresnel lens from a concave lens is most suitable as a Fresnel lens surface. Although this is most suitable, the linear Fresnel lens surfaces SrH and SrV may be adopted in the non-cross optical system.

In the above embodiments, the linear Fresnel lens surface SrH is obtained by forming a Fresnel lens by dividing, in the horizontal direction H, a concave lens having a concave shape in the horizontal direction H. However, the linear Fresnel lens surface SrH may be obtained by forming a Fresnel lens by dividing, in the horizontal direction H, a convex lens having a convex shape in the horizontal direction H. Moreover, the linear Fresnel lens surface SrV may be obtained by forming a Fresnel lens from a concave lens. The Fresnel lens surface Sf may be obtained by forming a Fresnel lens from a convex lens.

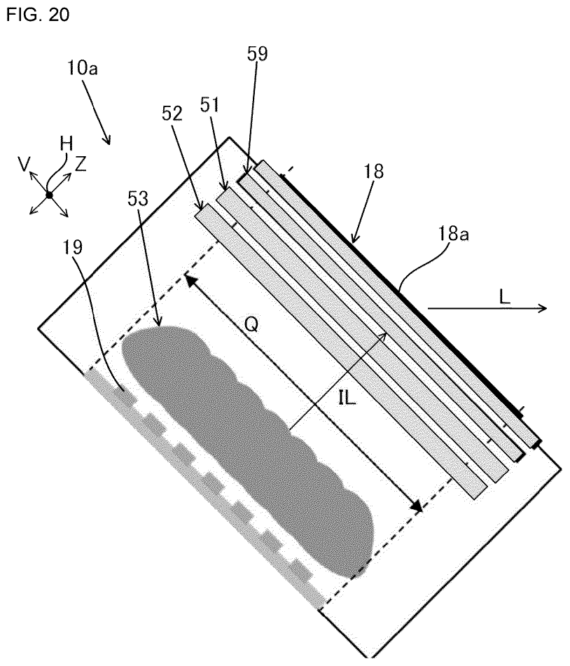

In the above embodiments and modifications, the first lens 51 is inclined and not orthogonal to the optical axes of the illumination light IL and the display light L, but is not limited thereto, and the first lens 51 may be orthogonal to the optical axis of the illumination light IL and may be inclined and not orthogonal to the optical axis of the display light L by changing the direction of light using a prism sheet (optical path changing means). For example, as illustrated in FIG. 20, the prism sheet 59 is arranged between the first lens 51 and the liquid crystal display panel 18, and has fine prisms that reflect the illumination light IL in a direction different from the parallel light traveling direction Z. The prism sheet 59 may be located not only between the first lens 51 and the liquid crystal display panel 18 but also between the first lens 51 and the second lens 52 or between the second lens 52 and the third lens 53. The size of a display device 10a can be reduced by using the prism sheet 59. Moreover, an illumination size Q is increased without changing the size of the intermediate image displayed on the display surface 18a. Therefore, in the local dimming function, the number of the dimming zones can be increased without changing the pitch of the light sources 19.

In the above conditions, the conditions other than the condition A may not be satisfied.

In the above embodiments and modifications, the display device 10 may be a laser scanning display device that displays an image on a screen by scanning the screen with emitted laser light.

The term “equal to or more than the absolute value” in the above embodiments can be replaced with “more than the absolute value.”

In the above embodiment, the first to third lenses 51 to 53 are formed in a rectangular plate shape, but are not limited thereto, and may be formed in, for example, a square, circular, elliptical, or polygonal plate shape.

In the above embodiment, the head-up display device 100 is mounted on the vehicle 200, but the head-up display device 100 may be mounted on other conveyances such as an airplane and a ship without being limited to the vehicle 200. The projection target member onto which the display light L is projected is not limited to the windshield 201, and may be a dedicated combiner.

In the above embodiment (particularly, in FIGS. 4 and 5), the concentric Fresnel lens surface Sf is formed by dividing a lens in the radial direction R and arranging the divided parts at the same height, but the concentric Fresnel lens surface Sf may be formed by, for example, the following techniques without being limited thereto.

In a first modified technique, a Fresnel lens surface may be formed such that the pitch of apexes of ridge portions (for example, the ridge portions Sf1) is constant in the radial direction R. According to this technique, even when a lens surface to be divided is an aspherical lens surface, the locus of a processing tool in mold processing can be a circular motion that is easily controlled on the XY plane, and the degree of difficulty in manufacturing can be reduced.

In a second modified technique, a Fresnel lens surface may be formed by combining the technique shown in the above embodiment and the first modified technique. Specifically, an upper limit is set for both the height (depth) and the pitch of the apexes of the ridge portions of the concentric

Fresnel lens surface, and a Fresnel lens surface may be formed by dividing the lens surface when one of them reaches the upper limit. For example, in the above embodiment, an example in which the upper limit of the depth is 0.1 mm and the pitch is not limited has been described. However, in this modified technique, the upper limit of the pitch may be set to 0.3 mm or the like while the upper limit of the depth is 0.1 mm. In order to reduce a stripe pattern due to moire, the upper limit of the pitch is preferably at least equal to or less than 0.3 mm.

In a third modified technique, a Fresnel lens surface may be formed by dividing the lens surface by a different technique for each region within the surface.

The technique of forming a Fresnel lens surface is not limited to the above techniques, and any optical surface dividing technique may be used.

Description of Embodiment in which Lens Center of Light Distribution Lens Surface is Made to be Eccentric

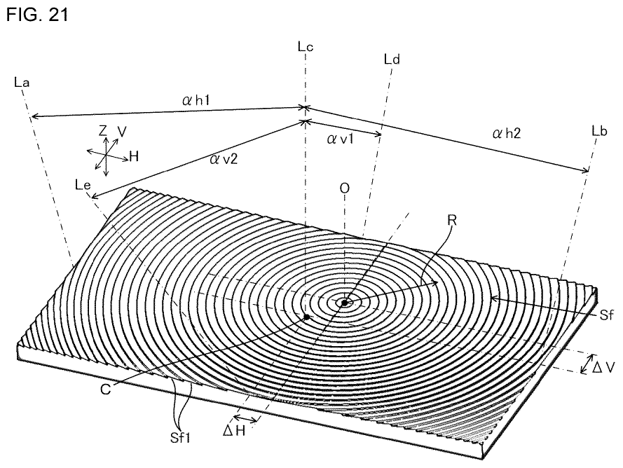

Hereinafter, the eccentricity of the lens central axis of the concentric Fresnel lens surface Sf as a light distribution lens surface will be described. As illustrated in FIG. 21, the lens eccentric central axis O located at the center of a concentric circle of the concentric Fresnel lens surface Sf is located at a position shifted from a lens area center C on an HV plane along the horizontal direction H and the vertical direction V. The lens area center C is located at the center of the entire area of the concentric Fresnel lens surface Sf (in the present example, the entire area of a rectangle that is long in the horizontal direction H and short in the vertical direction V). From another viewpoint, the lens area center C is located at a position corresponding to half the length of the concentric Fresnel lens surface Sf in each of the horizontal direction H and the vertical direction V. The lens eccentric central axis O is shifted by a shift amount ΔH in the horizontal direction H with respect to the lens area center C, and the lens eccentric central axis O is shifted by a shift amount ΔV in the vertical direction V with respect to the lens area center C.

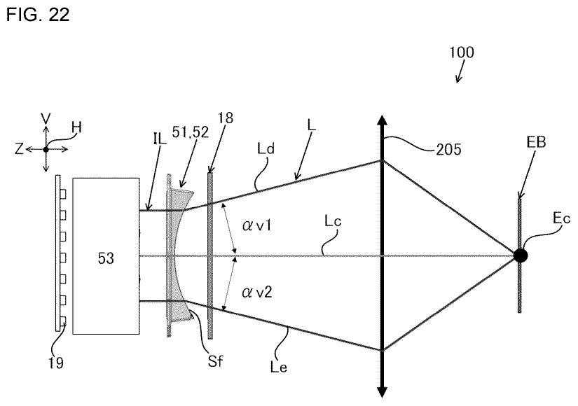

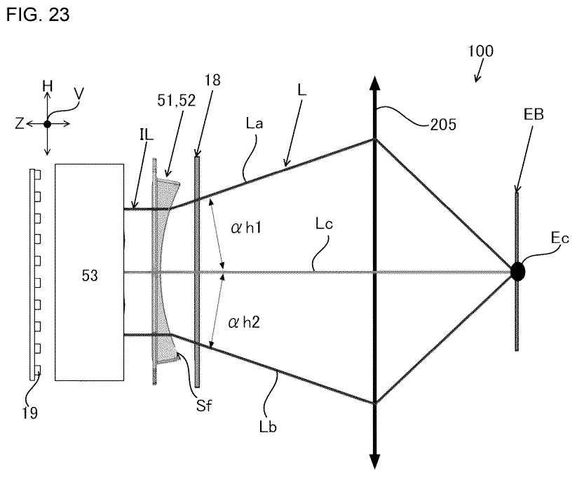

As illustrated in FIGS. 22 and 23, the head-up display device 100 includes the light sources 19, the lenses 51, 52, and 53, the liquid crystal display panel 18, and a projection optical system 205 including the mirrors 21 and 22 and the windshield 201. The display light L from the liquid crystal display panel 18 reaches the eyebox EB via the projection optical system 205. When the viewpoint of the viewer enters the eyebox EB, the viewer can visually recognize the virtual image W.

In FIGS. 22 and 23, the concentric Fresnel lens surface Sf is illustrated without being formed into a Fresnel lens.

As illustrated in FIGS. 21 and 23, the shift amount ΔH and a shift direction in the horizontal direction H are determined by emission angles αh1 and αh2 of the display light L from the liquid crystal display panel 18.

The emission angles αh1 and αh2 are angles formed by the outermost light beams La and Lb of the display light L in the horizontal direction H with respect to an optical axis center Lc (central display light, a line connecting the center of the screen of the liquid crystal display panel 18 and the center of the eyebox EB, also referred to as a gut ray). The light beams La and Lb are light beams tracing the display light L from a center position Ec of the eyebox EB. The lens area center C is located on an extended line of the optical axis center Lc. The light beam La is a light beam corresponding to a pixel at the left end portion of the virtual image W when viewed from the viewer, and the light beam Lb is a light beam corresponding to a pixel at the right end portion of the virtual image W when viewed from the viewer.

The emission angle αh1 is an angle formed by the light beam La with respect to the optical axis center Lc, and the emission angle αh2 is an angle formed by the light beam Lb with respect to the optical axis center Lc. The emission angles αh1 and αh2 are different from each other due to the shape of the windshield 201 asymmetric in the horizontal direction H and the inclination of the projection optical system 205. The lens eccentric central axis O is made to be eccentric in accordance with the emission angles αh1 and αh2 different from each other. Specifically, the lens eccentric central axis O is eccentric from the lens area center C toward the smaller one of the emission angles αh1 and αh2. In the example of FIG. 21, the emission angle αh2 is set to be an angle smaller than the emission angle αh1, that is, “αh2<αh1.” Therefore, the shift amount ΔH and the lens eccentric central axis O are set to be closer to the side of the light beam Lb than the lens area center C. As the difference between the emission angles αh1 and αh2 increases, the shift amount ΔH is set to be larger.

If the emission angle αh1 is smaller than the emission angle αh2, the shift amount ΔH and the lens eccentric central axis O are set to be closer to the side of the light beam La than the lens area center C.

When the emission angles αh1 and αh2 are the same, the shift amount ΔH is set to zero.

As illustrated in FIGS. 21 and 22, the shift amount ΔV and a shift direction in the vertical direction V are determined by emission angles αv1 and αv2. The emission angles αv1 and αv2 are angles formed by the outermost light beams Ld and Le of the display light L in the vertical direction V with respect to the optical axis center Lc. The light beam Ld is a light beam corresponding to a pixel at the upper end portion of the virtual image W when viewed from the viewer, and the light beam Le is a light beam corresponding to a pixel at the lower end portion of the virtual image W when viewed from the viewer. The light beams Ld and Le are light beams tracing the display light L from the center position Ec of the eyebox EB. The emission angle αv1 is an angle formed by the light beam Ld with respect to the optical axis center Lc, and the emission angle αv2 is an angle formed by the light beam Le with respect to the optical axis center Lc. The emission angles αv1 and αv2 are different from each other due to the shape of the windshield 201 asymmetric in the vertical direction V and the inclination of the projection optical system 205. The lens eccentric central axis O is made to be eccentric in accordance with the emission angles αv1 and αv2 different from each other. Specifically, the lens eccentric central axis O is eccentric from the lens area center C toward the smaller one of the emission angles αv1 and αv2. In the example of FIG. 21, the emission angle αv1 is set to be an angle smaller than the emission angle αv2, that is, “αv1<αv2.” Therefore, the shift amount ΔV and the lens eccentric central axis O are set to be closer to the side of the light beam Ld than the lens area center C. As the difference between the emission angles αv1 and αv2 increases, the shift amount ΔV is set to be larger.

If the emission angle αv2 is smaller than the emission angle αv1, the shift amount ΔV and the lens eccentric central axis O are set to be closer to the side of the light beam Le than the lens area center C.

When the emission angles αv1 and αv2 are the same, the shift amount ΔV is set to zero.

Next, a determination method of the lens eccentric central axis O will be described. This method is performed by experiment or simulation. First, a light distribution lens in which the lens eccentric central axis O is not eccentric is prepared, and the emission angles αh1, αh2, αv1, and αv2 in this light distribution lens are obtained. The shift amounts ΔH and ΔV are obtained from the emission angles αh1, αh2, αv1, and αv2 as described above, and the lens eccentric central axis O is determined.

As described in the above embodiment with reference to FIG. 1, the head-up display device 100 according to the present embodiment, as models 1 and 5, is a cross optical system in which the display light L is folded twice in the vertical direction V by the two mirrors 21 and 22, that is, the display light L is vertically folded and the number of times the display light L is folded is two, and the display light L crosses in the vertical direction V at the cross point CP.

In the model 1, for example, the emission angle αh1 may be set to 6.6 to 7.0°, preferably about 6.8°. The emission angle αh2 may be set to 5.0 to 5.4°, preferably about 5.2°. The emission angle αv1 may be set to 3.6 to 4.0°, preferably about 3.8°. The emission angle αv2 may be set to 5.7 to 6.1°, preferably about 5.9°.

In the model 5, for example, the emission angle αh1 may be set to 1.7 to 2.1°, preferably about 1.9°. The emission angle αh2 may be set to 7.0 to 7.4°, preferably about 7.2°. The emission angle αv1 may be set to 6.7 to 7.1°, preferably about 6.9°. The emission angle αv2 may be set to 6.9 to 7.3°, preferably about 7.1°.

In addition, the head-up display device 100, as a model 2, may be a non-cross optical system in which the display light L is vertically folded, the number of times the display light L is folded is one, and the display light L does not cross. In the model 2, for example, the emission angle αh1 may be set to 13.8 to 14.2°, preferably about 14.0°. The emission angle αh2 may be set to 12.7 to 13.1°, preferably about 12.9°. The emission angle αv1 may be set to 2.2 to 2.6°, preferably about 2.4°. The emission angle αv2 may be set to 2.6 to 3.0°, preferably about 2.8°.

In addition, the head-up display device 100, as models 3 and 4, may be a non-cross optical system in which the display light L is vertically folded, the number of times the display light L is folded is two, and the display light L does not cross.

In the model 3, for example, the emission angle αh1 may be set to 11.4 to 11.8°, preferably about 11.6°. The emission angle αh2 may be set to 12.0 to 12.4°, preferably about 12.2°. The emission angle αv1 may be set to 1.4 to 1.8°, preferably about 1.6°. The emission angle αv2 may be set to 1.3 to 1.7°, preferably about 1.5°.

In the model 4, for example, the emission angle αh1 may be set to 17.1 to 17.5°, preferably about 17.3°. The emission angle αh2 may be set to 14.6 to 15.0°, preferably about 14.8°. The emission angle αv1 may be set to 4.5 to 4.9°, preferably about 4.7°. The emission angle αv2 may be set to 4.8 to 5.2°, preferably about 5.0°.

The numerical values of the above-described models 1 to 5 are examples and can be changed as appropriate.

Modification of Embodiment in which Lens Center of Light Distribution Lens Surface is Made to be Eccentric

In the above embodiment, the concentric Fresnel lens surface Sf obtained by forming a Fresnel lens from a concave lens is adopted as a light distribution lens surface (field lens surface), but the concentric Fresnel lens surface Sf may not be formed into a Fresnel lens.

For example, the entire lens surface of the light distribution lens surface may have a concave shape, a convex shape, a spherical shape, a toroidal shape, or a biconic shape. In these cases, the lens eccentric central axis O passes through the lens vertex at which the inclination of the lens surface is minimum with respect to the HV plane. For example, when the entire lens surface is a concave lens surface having a concave shape, the lens eccentric central axis O passes through the deepest position of the concave lens surface, and the lens eccentric central axis O is made to be eccentric from the lens area center C by the shift amounts ΔH and ΔV. For example, when the entire lens surface is a convex lens surface having a convex shape, the lens eccentric central axis O passes through the highest position of the convex lens surface, and the lens eccentric central axis O is made to be eccentric from the lens area center C by the shift amounts ΔH and ΔV. In the above embodiment, the light distribution lens surface is preferably formed in a convex shape in the cross optical system. Accordingly, since the light from the light distribution lens surface converges, the display light L easily crosses.

In the above embodiment, one of the two shift amounts ΔH and ΔV may be set to zero. Specifically, the lens eccentric central axis O may be separated from the lens area center C only in the horizontal direction H, or may be separated from the lens area center C only in the vertical direction V. In this case, the light distribution lens surface is not limited to a concentric Fresnel lens surface, and may be a linear Fresnel lens surface. In a configuration in which the lens eccentric central axis O is separated from the lens area center C only in the vertical direction V, the lens having a light distribution lens surface can be used in common for a left-hand drive vehicle and a right-hand drive vehicle without rotating the lens. In the above embodiment, the projection optical system 205 includes the mirrors 21 and 22 and the windshield 201, but may include a single or a plurality of optical members such as a lens, a mirror, and a prism, and in the case of a plurality of optical members, the combination thereof can be freely selected.

In the above embodiment, the position of the light distribution lens surface can be changed as appropriate. For example, in a configuration in which a condenser lens is adopted as the third lens 53, a lenticular lens is adopted as the second lens 52, and a toroidal lens is adopted as the first lens 51, the above-described light distribution lens surface may be applied to a toroidal surface of the toroidal lens. In addition, in a configuration in which a condenser lens is adopted as the third lens 53, a lenticular lens is adopted as the second lens 52, and a Fresnel lens is adopted as the first lens 51, the above-described light distribution lens surface may be applied to the Fresnel lens.

According to the embodiment described above, the following effects are achieved.

(1) A head-up display device 100 projects display light L onto a windshield 201 mounted on a vehicle 200 to display a virtual image W as an example of a projection image visually recognizable from a visible range (eyebox EB). The head-up display device 100 includes: a light source 19 that emits illumination light IL; a third lens 53 as an example of a collimating means for collimating the illumination light IL emitted from the light source 19; a concentric Fresnel lens surface Sf as an example of a light distribution lens surface that distributes the illumination light IL in accordance with the eyebox EB, a liquid crystal display panel 18 as an example of a display panel that receives the illumination light IL to emit the display light L, and a projection optical system 205 including the windshield 201, which reflects the display light L and causes the display light L to pass therethrough to guide the display light L to the eyebox EB. The concentric Fresnel lens surface Sf is formed such that a lens eccentric central axis O of the concentric Fresnel lens surface Sf is eccentric from a lens area center C of the entire concentric Fresnel lens surface Sf by shift amounts ΔH and ΔV. According to this configuration, even when shifting or unevenness occurs in the display light L by the projection optical system 205 such as the windshield 201, the shifting or unevenness can be canceled by shifting of the lens central axis of the light distribution lens surface from the lens area center, and the illumination efficiency can be improved.

(2) A shift direction of the shift amount ΔV is a vertical direction V corresponding to an up-down direction of the virtual image W when viewed from a viewer.

According to this configuration, the concentric Fresnel lens surface Sf is formed so as to be bilaterally symmetrical in a horizontal direction H, more precisely, so as to be symmetrical with respect to a symmetry plane that extends along the vertical direction V and a parallel light traveling direction Z and is located at the center of the concentric Fresnel lens surface Sf in the horizontal direction H. Accordingly, the head-up display device 100 can be used in common for a left-hand drive vehicle and a right-hand drive vehicle.

(3) In the display light L emitted from the liquid crystal display panel 18, emission angles αh1, αh2, αv1, and αv2 of the display light L at pixels at both ends in a direction corresponding to a vertical direction V of the virtual image W when viewed from the viewer and at pixels at both ends in a direction corresponding to a horizontal direction H of the virtual image W when viewed from the viewer with respect to an optical axis center Lc are different from each other. A shift direction of the shift amount ΔH in the horizontal direction H is a direction corresponding to a pixel of the pixels at both ends, which has a smaller emission angle αh1 or αh2. A shift direction of the shift amount ΔV is a direction corresponding to a pixel of the pixels at both ends, which has a smaller emission angle αv1 or αv2. According to this configuration, the deterioration in the illumination efficiency due to the shape or the inclination of the projection optical system 205 can be suitably canceled by the eccentricity of the lens central axis of the light distribution lens surface. Specifically, on the lens surface, as the distance from the lens eccentric central axis O increases, the action of bending light increases. Therefore, the lens surface can enhance the action of bending light on the side of a larger emission angle αh1, αh2, αv1, or αv2, and thus the illumination efficiency can be improved.

(4) The projection optical system 205 includes a first mirror 21 as an example of a correction mirror that reflects the display light L and crosses one end and the other end of the display light L in a direction orthogonal to a display light traveling direction after the display light L is reflected. The light distribution lens surface of the first mirror 21 has a convex shape. In the cross optical system, the display light L reflected by the first mirror 21 converges toward the cross point CP. Therefore, the light distribution lens surface of the first mirror 21 is preferably formed in a convex shape to emit the display light L while the display light L converges.

(5) The light distribution lens surface is formed by a Fresnel lens surface having a Fresnel shape. According to this configuration, the thickness of the lens can be reduced by forming the light distribution lens surface into a Fresnel lens.

Problem of Embodiment in which Lens Center of Light Distribution Lens Surface is Made to be Eccentric

In the configuration described in Patent Document 1, there is room for improvement in the arrangement and type of each lens from the viewpoint of the uniformity of illumination with respect to the liquid crystal display panel.

More specifically, when the parallel illumination light is diffused only by a lenticular lens without the light distribution lens in each lens, a range wider than the eyebox is irradiated with the display light, and thus the light is wasted. In this regard, by adding the light distribution lens, the diffused illumination light is intensively distributed in the visible range, so that the display light can be efficiently delivered into the eyebox and the light efficiency is high.

In general, from the concept that it is efficient to position the lens center of the light distribution lens on the optical axis, the light distribution lens is configured as described above in Patent Document 1. However, in practice, the inventors have found that the configuration is not optimal from the viewpoint of the uniformity of illumination.

The present embodiment has been made in view of the above circumstances, and an object of the present embodiment is to provide a head-up display device capable of further increasing the uniformity.

In order to achieve the above object, for example, technical ideas described in the following Supplementary Notes 1 to 5 are disclosed in the above-described embodiment in which the light distribution lens surface is made to be eccentric.

### Supplementary Note 1

A head-up display device that projects display light onto a windshield mounted on a vehicle to display a projection image visually recognizable from an eyebox, including:
a light source that emits illumination light;
a collimating means for collimating the illumination light emitted from the light source;
a light distribution lens surface that distributes the illumination light from the collimating means, and
a display panel that receives the illumination light from the light distribution lens surface to emit the display light, in which
the light distribution lens surface is formed such that a lens center of the light distribution lens surface is eccentric from a center position of the entire light distribution lens surface by a shift amount.

### Supplementary Note 2

The head-up display device according to supplementary note 1, in which
a shift direction of the shift amount is a vertical direction corresponding to an up-down direction of the projection image when viewed from a viewer.

### Supplementary Note 3

The head-up display device according to supplementary note 1, in which,
in the display light emitted from the display panel, emission angles of the display light at pixels at both ends in a direction corresponding to a vertical direction or a horizontal direction of the projection image when viewed from a viewer with respect to an optical axis center corresponding to the center position are different from each other, and
a shift direction of the shift amount is a direction corresponding to a pixel of the pixels at both ends, which has a smaller emission angle.

### Supplementary Note 4

The head-up display device according to any one of supplementary notes 1 to 3, including: a projection optical system that reflects the display light or causes the display light to pass therethrough to guide the display light to the eyebox, in which
the projection optical system includes a correction mirror that reflects the display light and crosses one end and the other end of the display light in a direction orthogonal to a display light traveling direction after the display light is reflected, and
the light distribution lens surface has a convex shape.

### Supplementary Note 5

The head-up display device according to any one of supplementary notes 1 to 3, in which
the light distribution lens surface has a Fresnel shape.

### REFERENCE SIGNS LIST

10, 10a display device
14 case
14a opening portion
15 illumination device
16 substrate
17 light diffusion member
18 liquid crystal display panel
18a display surface
18b image display region
18z dimming zone
19 light source
21, 21a first mirror
22 second mirror
25 control unit
30 housing
30c opening portion
31 window portion
51 to 53 first to third lenses
51i, 52i incident surface
51o, 52o emission surface
53a convex lens portion
59 prism sheet
100 head-up display device
200 vehicle
201 windshield
205 projection optical system
Sb biconic lens array surface
Sb1 microlens portion
Sc cylindrical lens surface
Sc1 cylindrical lens portion
Sf concentric Fresnel lens surface
Sf1 ridge portion
Sf2 Fresnel inclined surface
Sf3 side surface
SrH horizontal light distribution linear Fresnel lens surface
Sr1 ridge portion
Sr2 Fresnel inclined surface
Sr3 side surface
SrV vertical light distribution linear Fresnel lens surface
Sra ridge portion
Srb Fresnel inclined surface
Src side surface
H horizontal direction, V vertical direction
Z parallel light traveling direction
θ light distribution angle
α angle

C lens area center
C1, C2, C3 curvature
EB eyebox
J center plane
L display light
O eccentric central axis
P lens pitch
Q illumination size
R radial direction
W virtual image
W1 arrangement direction
L1 extending direction
Lc optical axis center
CP cross point
IL illumination light
ΔH, ΔV shift amount
αh1, αh2, αv1, αv2 emission angle

1. A display device that emits display light representing an image, comprising:
a light source that emits light;
a collimating means for collimating the light from the light source;
a plurality of light distribution optical surfaces that distribute the light collimated by the collimating means and are arranged on an optical axis of the collimated light; and
a display surface that receives the light distributed by the plurality of light distribution optical surfaces to emit the display light and is provided in a direction inclined with respect to an optical axis of the emitted display light, wherein
a first light distribution optical surface of any of the plurality of light distribution optical surfaces is a Fresnel lens surface provided in a direction along the display surface, and
a second light distribution optical surface of any of the plurality of light distribution optical surfaces is a lenticular lens surface or a biconic lens array surface.

2. The display device according to claim 1, wherein
the second light distribution optical surface is one of two second light distribution optical surfaces,
one of the two second light distribution optical surfaces is a first lenticular lens surface that
distributes light in a vertical direction, the other of the two second light distribution optical surfaces is a second lenticular lens surface that distributes light in a horizontal direction,
the first lenticular lens surface is provided in a direction orthogonal to the optical axis of the collimated light, and
the vertical direction and the horizontal direction are set to be orthogonal to the optical axis and in directions orthogonal to each other.

3. The display device according to claim 1, wherein
the second light distribution optical surface is one of two second light distribution optical surfaces, and
an absolute value of a curvature radius of a first lenticular lens surface that is one of the two second light distribution optical surfaces is set to be equal to or more than an absolute value of a curvature radius of a second lenticular lens surface that is the other of the two second light distribution optical surfaces, which is located farther from the display surface than the first lenticular lens surface.

4. A head-up display device comprising:
the display device according to claim 1; and
a mirror that reflects the display light from the display device, wherein
the mirror reflects the display light so as to cross an upper end and a lower end of the display light, which are both ends in the vertical direction,
the Fresnel lens surface as the first light distribution optical surface is a linear Fresnel lens surface obtained by forming a Fresnel lens from a convex lens that extends linearly with a curvature of zero in the horizontal direction and has a convex shape in the vertical direction, and
the vertical direction and the horizontal direction are set to be orthogonal to the optical axis of the collimated light and in directions orthogonal to each other.
